(19) United States
(12) Patent Application Publication
(10) Pub. No.: US 2015/0158709 A1
(43) Pub. Date: Jun. 11, 2015

(54) MULTI-PURPOSE CONTAINER OPENING DEVICE

(71) Applicant: Phillip Stewart Muhlfelder, Willoughby, OH (US)

(72) Inventor: Phillip Stewart Muhlfelder, Willoughby, OH (US)

(21) Appl. No.: 14/100,961

(22) Filed: Dec. 9, 2013

(51) Int. Cl. B67B 7/14; B67B 7/40

(52) U.S. Cl. CPC B67B 7/14; B67B 7/403

(57) ABSTRACT

A multi-use container opener device may include a base and a cover. A cap engagement lever arm and a ring-top opener shaft may be sandwiched in between the cover and the base. A first end and a second end of the cover may include at least two holes. The cover may attach to the base having the at least two holes aligned with a first pivot post of the base and a second pivot post of the base. In certain embodiments, multiple cap engagement lever arms are sandwiched in between the cover and the base. In certain embodiments, an integral handle may be attached to the ring-top opener shaft.

### BACKGROUND OF THE INVENTION

The present invention relates to container openers and, more particularly, to a multi-purpose container opener device.

Currently, people, and especially children and the elderly, often experience difficulty breaking the tamper seal and opening various containers found around the home. These containers include, but are not limited to, prescription vials and other twist off closures. In addition, these same people often experience difficulty opening ring top cans.

As can be seen, there is a need for a multi-purpose container opening device that may open multiple types of container lids, seals and the like.

### SUMMARY OF THE INVENTION

In one aspect of the present invention, a multi-use container opening device comprises: a base having a first end and a second end, wherein the first end comprises at least one cap receiver and a first pivot post, wherein the second end comprises a second pivot post; a cap engagement lever arm comprising a first pivot hole, wherein the first pivot post of the base engages with the first pivot hole; a ring-top opener shaft having a first end and a second end, wherein the first end comprises a sharpened nose, wherein the second end comprises a second pivot hole, wherein the second pivot post of the base engages with the second pivot hole; and a cover having a first end and a second end, comprising at least two holes, wherein the cover attaches to the base having the at least two holes aligned with the first pivot post of the base and the second pivot post of the base, wherein the cap engagement lever arm and the ring-top opener shaft are sandwiched in between the cover and the base.

In another aspect of the present invention, a method of opening a ring top container comprises: providing a multi-use container opening device comprising a base having a first end and a second end, wherein the first end comprises at least one cap receiver and a first pivot post, wherein the second end comprises a second pivot post, a cap engagement lever arm comprising a first pivot hole, wherein the first pivot post of the base engages with the first pivot hole, a ring-top opener shaft having a first end and a second end, wherein the first end comprises a sharpened nose, wherein the second end comprises a second pivot hole, wherein the second pivot post of the base engages with the second pivot hole; and a cover having a first end and a second end, comprising at least two holes, wherein the cover attaches to the base having the at least two holes aligned with the first pivot post of the base and the second pivot post of the base, wherein the cap engagement lever arm and the ring-top opener shaft are sandwiched in between the cover and the base; depressing an end of the ring-top opener shaft position lock release rocker to release a retainer ledge from the ring-top shaft open position locking notch; rotating the ring-top opener shaft into an open configuration; moving a sharpened nose of the ring-top opener shaft under the ring of a container top; pushing down on device, thereby lifting the ring of the container top; pushing the ring-top opener shaft through the ring until the stop on the shaft engages the top of the container; pulling up on the device to break the seal and open the container.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use opening a screw-on container cap;

FIG. 2 is a top perspective view of an exemplary embodiment of the present invention;

FIG. 3 is a bottom perspective view of an exemplary embodiment of the present invention shown with all cap receivers are tangent at an engagement area;

FIG. 4 is an exploded view of an exemplary embodiment of the present invention;

FIG. 5 is a section view of an exemplary embodiment of the present invention, taken along line 5-5 in FIG. 2;

FIG. 6 is a section view of an exemplary embodiment of the present invention, illustrating a cap engagement lever arm in its cap engagement position;

FIG. 7 is a section view of an exemplary embodiment of the present invention, taken along line 7-7 in FIG. 6, with the cap engagement lever arm in its cap engagement position;

FIG. 8 is a perspective view of an exemplary embodiment of the present invention, shown in use opening a ring-top can;

FIG. 9 is a detail section view of an exemplary embodiment of the present invention, illustrating the depression of a ring-top shaft position lock release rocker and subsequent release and rotation of a ring-top opener shaft;

FIG. 10 is a detail section view of an exemplary embodiment of the present invention, illustrating the ring-top opener shaft in its open and locked position;

FIG. 11 is a detail section view of an exemplary embodiment of the present invention, taken along line 11-11 in FIG. 9;

FIG. 12 is a section view of an exemplary embodiment of the present invention, taken along line 12-12 in FIG. 8;

FIG. 13 is a top perspective view of an alternate embodiment of the present invention with two cap receivers at opposing ends of the invention;

FIG. 14 is a bottom perspective view of an alternate embodiment of the invention, showing multiple level cap receivers at opposing ends; all cap receivers tangent at the insert;

FIG. 15 is a detail section view of an exemplary embodiment of the present invention, taken along line 15-15 in FIG. 13;

FIG. 16 is a perspective view of an alternate embodiment of the present invention; and

FIG. 17 is a side view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-use container opener that may include a base having a first end and a second end. The first end may include at least one cap receiver and a first pivot post, while the second end may include a second pivot post. A cap engagement lever arm may include a first pivot hole. The first pivot post of the base may engage with the first pivot hole. A ring-top opener shaft may have a first end and a second end, and may have the first end include a sharpened nose, and the second end may include a second pivot hole. The second pivot post of the base may engage with the second pivot hole. A cover having a first end and a second end may include at least two holes. The cover may attach to the base having the at least two holes aligned with the first pivot post of the base and the second pivot post of the base. The cap engagement lever arm and the ring-top opener shaft may be sandwiched in between the cover and the base.

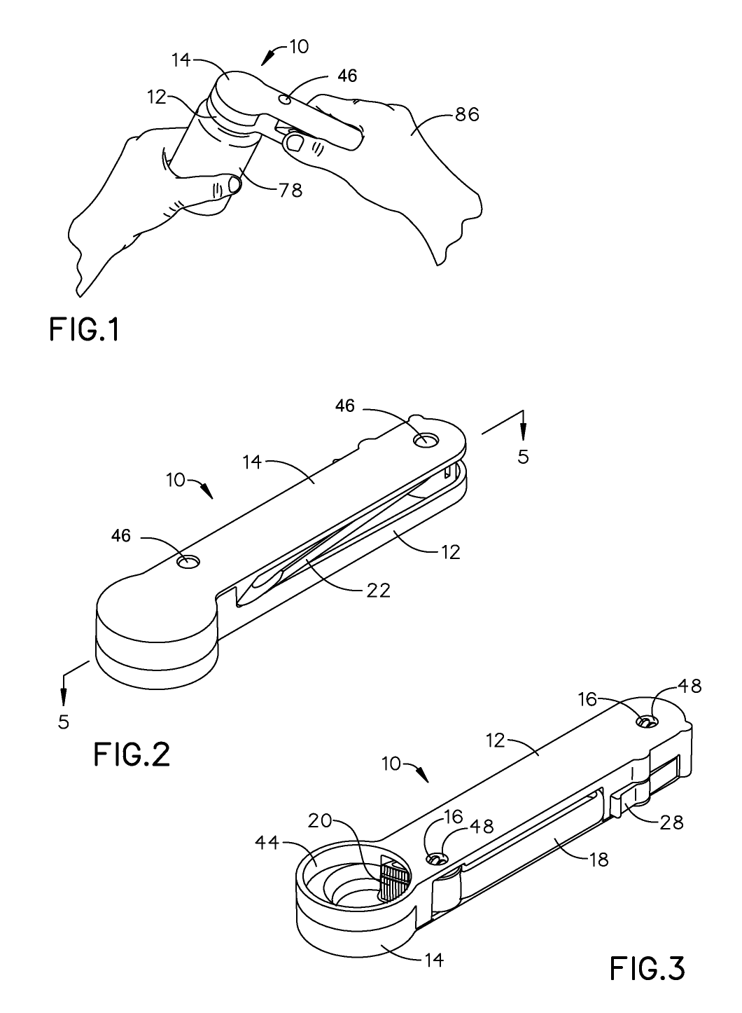

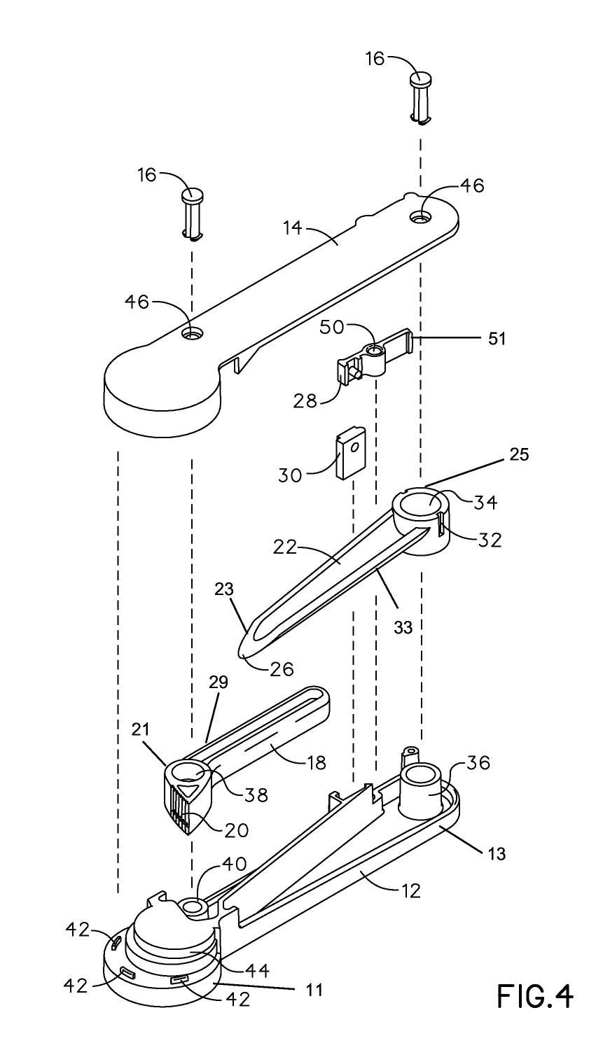

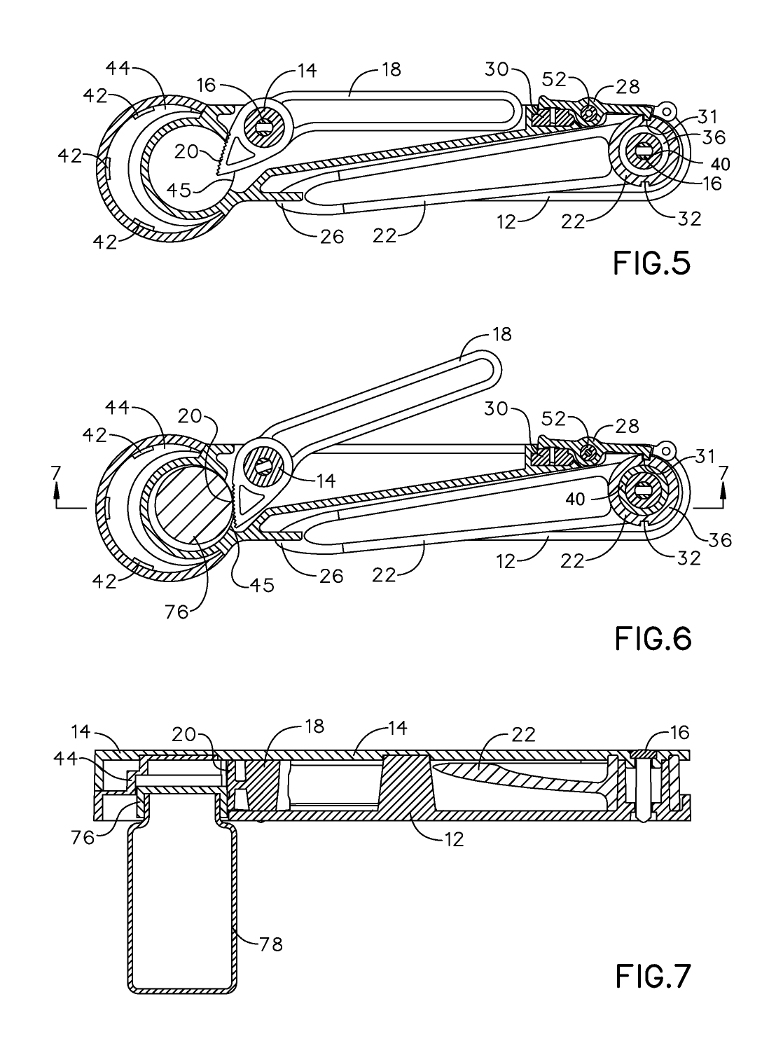

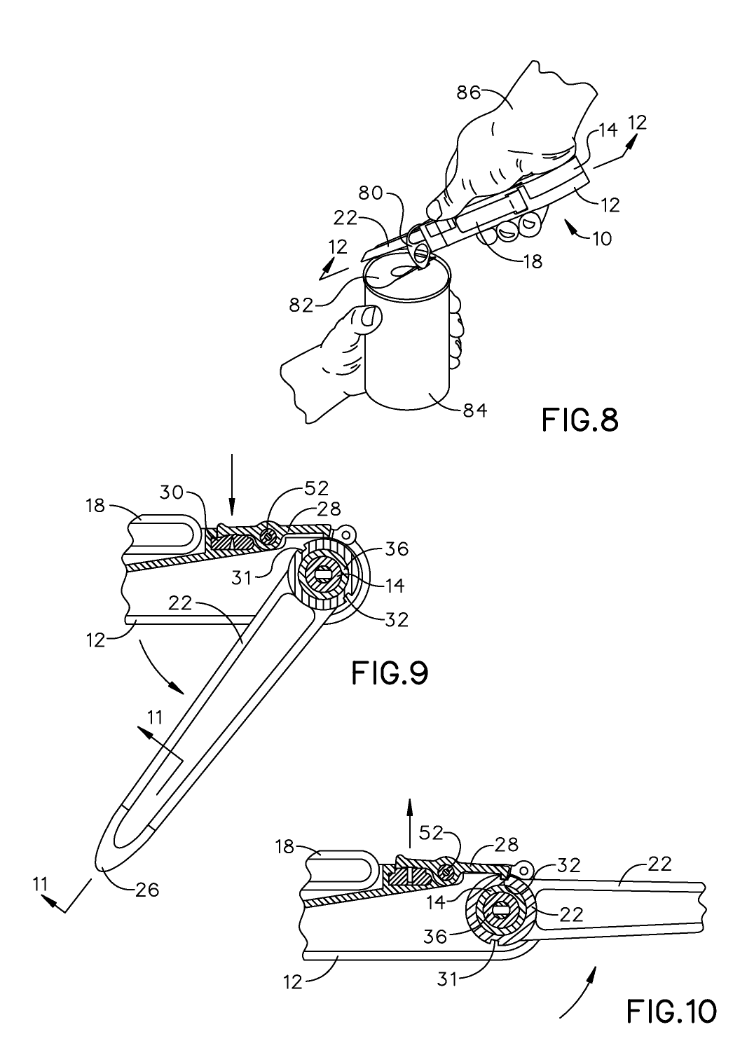

As is illustrated in FIGS. 1 through 17, the present invention 10 may include a base 12. The base 12 may include a first end 11 and a second end 13. The first end 11 of the base 12 may include at least one cap receiver 44. In certain embodiments, the at least one cap receiver 44 may include a plurality of stepped cap receivers, wherein all cap receivers may be tangent along a side of engagement 45. In certain embodiments, the at least one cap receiver 44 may include three stepped cap receivers. A first pivot post 40 may reside along the first end 11 of the base 12. The second end 13 of the base 12 may include a second pivot post 36. A first container opener component 29 may be placed on the base 12. In certain embodiments, a cap engagement lever arm 18 may be placed so that a first pivot hole 38 on the cap engagement lever arm 18 may engage with the first pivot post 40 of the base 12. In certain embodiments, the cap engagement lever arm 18 may also include a gripping surface 20 along a first end 21. The gripping surface 20 may be slotted, a soft plastic or the like.

In certain embodiments, a second container opener component 33 may be placed on the base 12. In certain embodiments, a ring-top opener shaft 22 may have a first end 23 and a second end 25. The ring-top opener shaft 22 may be placed so that a second pivot hole 34 of the ring-top opener shaft 22 may engage with the second pivot post 36. The second end 25 of the ring-top opener shaft 22 may include the second pivot hole 34 and along the second pivot hole 34 may be a ring-top shaft open position locking notch 32 and a ring-top shaft closed position locking notch 31. The first end 23 of the ring-top opener shaft 22 may include a sharpened nose 26. Towards the sharpened nose 26 along the first end 23 may be a edge stop 24 located on a base side of the ring-top opener shaft 22.

In certain embodiments, a spring 30 and a ring-top shaft position lock release rocker 28 may attach to the base 12. The ring-top shaft position lock release rocker 28 may include a third pivot hole 50 and a retainer ledge 51. The third pivot hole 50 may engage with a third pivot post 52 located along the base 12. The retainer ledge 51 of the ring-top shaft position lock release rocker 28 may engage and slide into the ring-top shaft open position locking notch 32 for an open configuration and slide into the ring-top shaft closed position locking notch 31 for a closed configuration. The spring may be made from a material such as foam, metal or the like.

A cover 14 may attach to the base 12. The cover 14 may include at least two holes 46. The at least two holes 46 may align with the first pivot post 40 and the second pivot post 36, thereby sandwiching the cap engagement lever arm 18 and ring-top opener shaft 22 in between the cover 14 and the base 12. In certain embodiments, at least two latch pins 16 may be inserted into the at least two holes 46 of the cover 14, and engaging with the first pivot post 40 and the second pivot post 36 as well as at least two latch pin holes 48 located on the base 12. In certain embodiments, a plurality of cover support tabs 42 may be located on the first end 11 of the base 12.

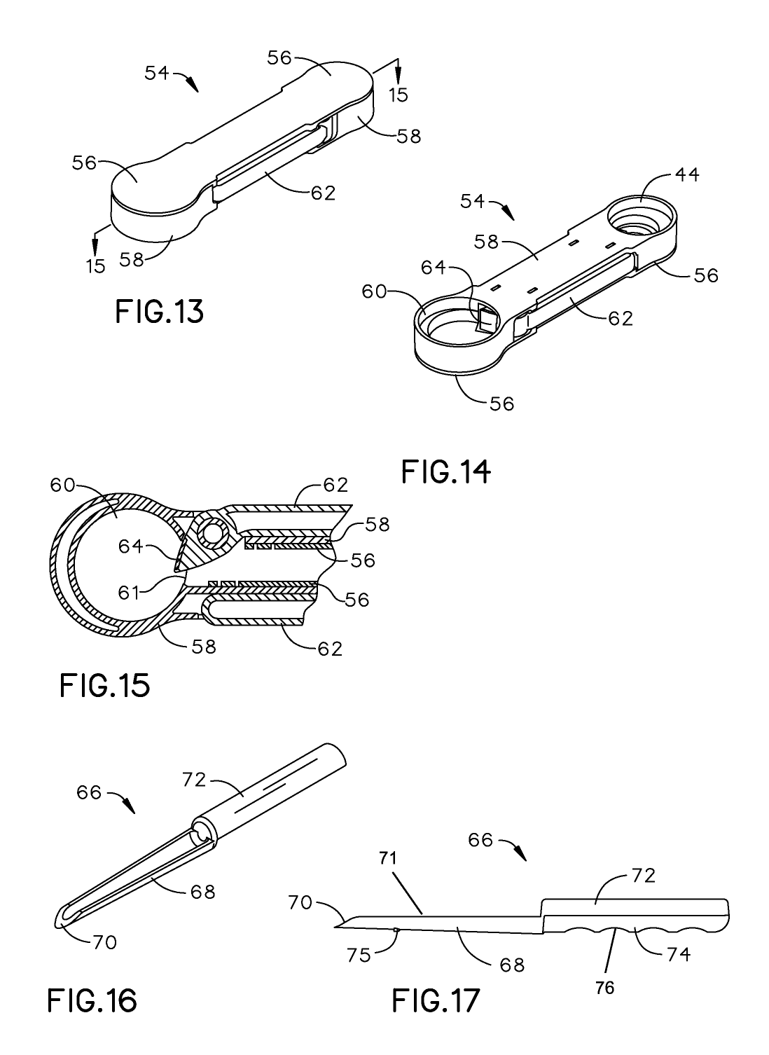

In alternate embodiments, both the first container opener component 29 and the second container opener component 33 may each be a cap engagement lever arm 18. An alternate embodiment 54 such as shown in FIGS. 13 through 15 may have an alternate cover 56 and an alternate base 58. At least one stepped cap receiver 60 may be used where a separate stepped cap receiver tangency point 61 may be distinguished. In certain embodiments, two stepped cap receivers 60 may be used where a separate stepped cap receiver tangency point 61 may be distinguished. The alternate cap engagement lever arm 62 may include an insert 64 for screw-on metal caps. The insert 64 may be made from a soft plastic or the like.

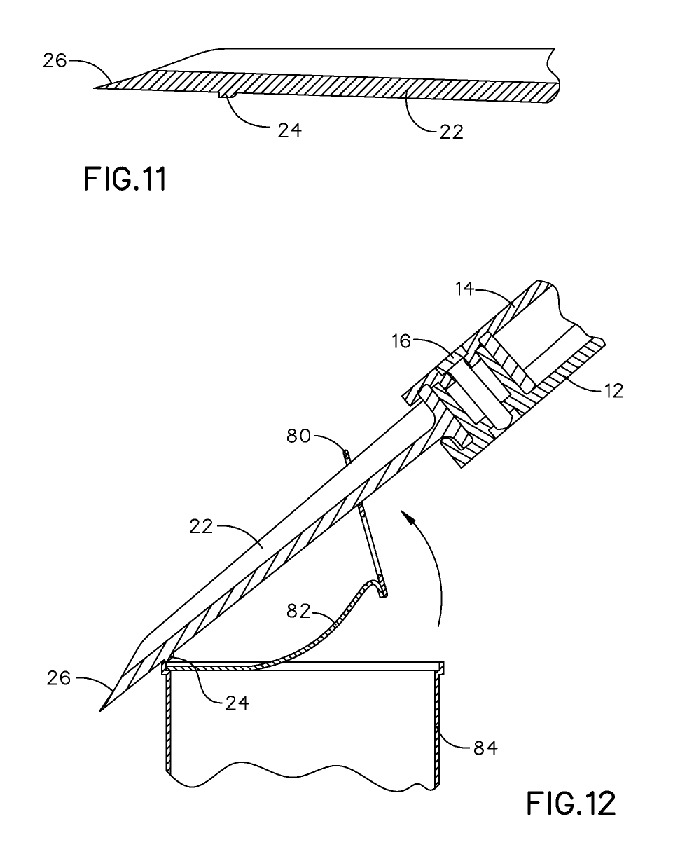

In alternate embodiments, a ring-top can shaft with an integral handle 66 may be included. The ring-top can shaft with an integral handle 66 may have an sharpened nose area 70 along a first end 71. The first end 71 may also include an edge stop 75. The cross section of the first end 71 may be similar to what is shown in FIG. 11. The handle 72 may have a grip 74 along a second end 76.

A method for using the present invention may include the following. In certain embodiments, the device works through rotation of the cap engagement lever arm 18 to temporarily pinch container caps 76 between itself and the circumference of one of the cap receivers 44 on the base 12. The various diameter cap receivers 44 may all be tangent on one side which may allow the cap engagement lever arm 18 to contact whichever size cap 76 may be inserted and opened. Once a cap 76 may be temporarily pinched and retained, the entire device 10 may be rotated counter clockwise to break tamper seals and release thread tension from the cap 76 so that the cap 76 may be removed from the container 78. The ring-top opener shaft 22 may function through use of a sharpened nose 26 to initially select and raise a pull tab 80 of the can 84. The pull tab 80 may be ring shaped. Leveraging the sharp nose 26 under the ring shaped pull tab 80, the operator 86 may then push downward on the device 10. This action may cause the ring-top opener shaft 22 to push against the top edge of the can 84 which may cause the can 84 edge to temporarily serve as a fulcrum. The operator 86 may then start pushing the device 10 downward which may result in the pull tab 80 being forced upward a sufficient amount to then push the remainder of the ring-top opener shaft 22 through the center of the ring shaped pull tab 80. Once the edge stop 24 on the base side of the ring-top opener shaft 22 reaches the opposing top edge of the can 84, the operator 86 may then lift the device 10. This action may force the can 84 top edge to again act as a temporary fulcrum. The leverage provided by the upward force may cause the attached ring shaped pull tab 80 to pull up on the cover 82 of the can 84. Pulling up on the cover 82 of the can 84 may prompt the retaining seal of the can 84 to tear thereby opening the can 84.

It should be understood, of course, that the foregoing relates to exemplary embodiments of the invention and that modifications may be made without departing from the spirit and scope of the invention as set forth in the following claims.

What is claimed is:

1. A multi-use container opening device comprising:
a base having a first end and a second end, wherein the first end comprises at least one cap receiver and a first pivot post, wherein the second end comprises a second pivot post;
a first container opener component comprising a first pivot hole, wherein the first pivot post of the base engages with the first pivot hole;
a second container opener component having a first end and a second end, wherein the second end comprises a second pivot hole, wherein the second pivot post of the base engages with the second pivot hole; and
a cover having a first end and a second end, comprising at least two holes, wherein the cover attaches to the base having the at least two holes aligned with the first pivot post of the base and the second pivot post of the base, wherein the first container opener component and the second container opener component are sandwiched in between the cover and the base.

2. The multi-use container opening device of claim 1, wherein the first container opener component comprises a cap engagement lever arm.

3. The multi-use container opening device of claim 1, wherein the second container opener component comprises a ring-top opener shaft, wherein the first end comprises a sharpened nose.

4. The multi-use container opening device of claim 1, wherein the cover attaches to the base by at least two latch pins inserted into the at least two holes in the cover, wherein the at least two latch pins engage with the first pivot post and the second pivot post to secure the base to the cover.

5. The multi-use container opening device of claim 1, further comprising a plurality of cover support tabs attached to the first end of the base.

6. The multi-use container opening device of claim 2, wherein the cap engagement lever arm further comprises a slotted gripping surface on a first end.

7. The multi-use container opening device of claim 2, wherein the cap engagement lever arm further comprises a soft plastic gripping surface on a first end.

8. The multi-use container opening device of claim 3, wherein the ring-top opener shaft further comprises a ring-top shaft open position locking notch and a ring-top shaft closed position locking notch along the outside of the second pivot hole.

9. The multi-use container opening device of claim 8, further comprising a spring and a ring-top shaft position lock release rocker having a retainer ledge, wherein the spring and ring-top shaft position lock release rocker are positioned so that the spring pushes on the ring-top shaft position lock release rocker, wherein the retainer ledge of the ring-top shaft position lock release rocker slides into the ring-top shaft open position locking notch of the ring-top opener shaft for an open configuration, wherein the retainer ledge of the ring-top shaft position lock release rocker slides into the ring-top shaft closed position locking notch of the ring-top opener shaft for a closed configuration.

10. The multi-use container opening device of claim 2, wherein the at least one cap receiver comprises three stepped cap receivers, wherein all cap receivers are tangent along a side where the cap engagement lever arm engages a cap.

11. The multi-use container opening device of claim 2, wherein the cap engagement lever arm further comprise an insert, wherein the insert is the engagement point with a cap.

12. The multi-use container opening device of claim 1, wherein the second container opener component comprises a ring-top can shaft with an integral handle.

13. A method of opening a ring top container comprising:
providing a multi-use container opening device comprising a base having a first end and a second end, wherein the first end comprises at least one cap receiver and a first pivot post, wherein the second end comprises a second pivot post, a cap engagement lever arm comprising a first pivot hole, wherein the first pivot post of the base engages with the first pivot hole, a ring-top opener shaft having a first end and a second end, wherein the first end comprises a sharpened nose, wherein the second end comprises a second pivot hole, wherein the second pivot post of the base engages with the second pivot hole; and a cover having a first end and a second end, comprising at least two holes, wherein the cover attaches to the base having the at least two holes aligned with the first pivot post of the base and the second pivot post of the base, wherein the cap engagement lever arm and the ring-top opener shaft are sandwiched in between the cover and the base;
depressing an end of the ring-top opener shaft position lock release rocker to release a retainer ledge from the ring-top shaft open position locking notch;
rotating the ring-top opener shaft into an open configuration;
moving a sharpened nose of the ring-top opener shaft under the ring of a container top;
pushing down on device, thereby lifting the ring of the container top;
pushing the ring-top opener shaft through the ring until the stop on the shaft engages the top of the container;
pulling up on the device to break the seal and open the container.
